(19) United States
(12) Patent Application Publication
(10) Pub. No.: US 2025/0383990 A1
(43) Pub. Date: Dec. 18, 2025

(54) SYSTEM AND METHOD FOR IMPLEMENTING GPU MULTI-TAG CACHE ARCHITECTURE

(71) Applicant: Samsung Electronics Co., Ltd., Gyeonggi-do (KR)

(72) Inventors: Yang JIAO, San Jose, CA (US); Ping CHEN, Fremont, CA (US); Brian Connor SCHWEDOCK, San Jose, CA (US); Nhon QUACH, San Jose, CA (US); Tarun NAKRA, Austin, TX (US)

(21) Appl. No.: 19/050,492

(22) Filed: Feb. 11, 2025

Related U.S. Application Data
(60) Provisional application No. 63/661,299, filed on Jun. 18, 2024.

(51) Int. Cl. G06F 12/0802

(52) U.S. Cl. CPC G06F 12/0802; G06F 2212/60

(57) ABSTRACT

A system and a method are disclosed. The method includes the steps of storing a first portion of a first compressed tile in a first cache line of a cache storage device, and storing a second portion of the first compressed tile in a second cache line of a cache storage device.

### CROSS-REFERENCE TO RELATED APPLICATION

This application claims the priority benefit under 35 U.S.C. § 119 (e) of U.S. Provisional Application No. 63/661,299, filed on Jun. 18, 2024, the disclosure of which is incorporated by reference in its entirety as if fully set forth herein.

### TECHNICAL FIELD

The disclosure relates generally to cache memory architectures in system-on-chip (SoC) designs. More particularly, the subject matter disclosed herein relates to improvements in cache memory systems optimized for graphics processing unit (GPU) workloads, specifically addressing challenges in efficiently storing and retrieving large compressed tiles of data in GPU-intensive applications.

### SUMMARY

In mobile and embedded systems, SoCs incorporate a variety of processing units, including central processing units (CPUs), GPUs, and/or neural processing units (NPUs). The last-level cache (LLC) is typically shared among all these processing units to optimize overall system performance and power efficiency. However, many LLC architectures are primarily optimized for CPU workloads, with cache line sizes (e.g., 64 bytes) that are not well suited for the large, tile-based memory access patterns used with GPUs. As a result, GPUs face inefficiencies when using the LLC, leading to cache fragmentation, reduced effective cache capacity, and suboptimal performance in graphics-intensive applications.

To address these types of problems, existing solutions have attempted to optimize the LLC for general SoC performance by balancing the needs of different processing units. However, these approaches often fall short for GPU-centric workloads, where the GPU demands large amounts of memory bandwidth and capacity. The use of small cache lines optimized for CPU access exacerbates cache fragmentation when handling GPU tile-based data, reducing overall system efficiency.

One issue with the above approach is that previous solutions' caches do not account for the unique memory access requirements of GPUs, particularly the need to store and retrieve large, compressed tiles of data. This results in wasted cache space and increased memory traffic, as more cache lines are required to store the same amount of data. Furthermore, traditional caches do not adequately prioritize GPU performance, leading to latency issues and bottlenecks in GPU-heavy workloads.

To overcome these issues, systems and methods are described herein for a GPU multi-tag cache architecture, a cache memory design optimized for handling GPU workloads efficiently. The multi-tag cache architecture introduces a multi-tag system, allowing each cache line to at least partially store two or more compressed GPU tiles. The cache line size is increased (e.g., 4 kilobytes (KBs)) and divided into smaller sectors (e.g., 32 bytes), with each tag specifying a starting sector and size of a compressed tile within the line. This design reduces cache fragmentation, increases effective cache capacity, and improves GPU performance by enabling more efficient use of cache lines.

The above approaches improve on previous methods because the multi-tag system allows the GPU to store two or more portions of or entire tiles in a single cache line, reducing the number of cache lines needed for a given workload. This results in higher cache hit rates, lower memory traffic, and improved performance in GPU-related applications such as gaming and 3D rendering. By optimizing the cache architecture specifically for GPU tile-based compression, the multi-tag cache architecture enhances overall system efficiency for modern high-performance SoCs.

In an embodiment, a cache storage device comprises a first cache line storing a first portion of a first compressed tile; and a second cache line storing a second portion of the first compressed tile.

In another embodiment, a method comprises storing a first portion of a first compressed tile in a first cache line of a cache storage device; and storing a second portion of the first compressed tile in a second cache line of a cache storage device.

In another embodiment, a cache storage device comprises a first cache line storing a first portion of a compressed tile in a sector of the first cache line based on a tag assigned to the first cache line; and a second cache line storing a second portion of the compressed tile in a sector of the second cache line based on a tag assigned to the second cache line.

### BRIEF DESCRIPTION OF THE DRAWINGS

In the following section, the aspects of the subject matter disclosed herein will be described with reference to exemplary embodiments illustrated in the figures, in which:

FIG. 1 is a block diagram depicting a subsystem memory hierarchy, according to an embodiment;

FIG. 2A illustrates a configuration of tags, according to an embodiment;

FIG. 2B illustrates a configuration of a cache line having M+1 sectors, according to an embodiment;

FIG. 3A illustrates line 0 of a multi-tag cache line example with two tags per line, according to an embodiment;

FIG. 3B illustrates line 1 of a multi-tag cache line example with two tags per line, according to an embodiment;

FIG. 4A illustrates three tiles having different data sizes, according to an embodiment;

FIG. 4B illustrates a single-tag design requiring 3 lines to store the tiles shown in FIG. 4A, according to an embodiment;

FIG. 4C illustrates a multi-tag design requiring 2 lines to store the tiles shown in FIG. 4A, according to an embodiment;

FIG. 5 illustrates reading data from cache lines of a first size based on one or more requests, according to an embodiment;

FIG. 6 illustrates reading data from cache lines of a second size larger than the first size based on one or more requests, according to an embodiment;

FIG. 7 is a flowchart illustrating a multi-tag cache architecture method, according to an embodiment; and

FIG. 8 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and case of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module.

For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

“Tile” as used herein refers to a fixed-size block of data, typically representing a grid of pixels used in graphics processing. Tiles are fundamental units in tile-based rendering systems and are often compressed to reduce the amount of data that needs to be stored or processed. Some examples of tiles are 8×8 pixel blocks, 16×16 pixel blocks, or 32×32 pixel blocks, commonly used in GPU rendering tasks.

“Sector” as used herein refers to a fixed-size subdivision of a cache line, which serves as a unit for storing data within the cache. Each sector contains a portion of a compressed tile, allowing for fine-grained control over how data is packed into the cache. Some examples of sectors are segments of 32 bytes or more within a cache line, where each sector helps manage and align tile data across the cache.

“Line” as used herein refers to a cache line, which is a contiguous block of memory within a cache used to store data, typically including multiple sectors. Cache lines are the primary storage units in the cache and can hold one or more compressed tiles depending on the compression ratio. Some examples of lines are 4 KB cache lines that store large amounts of compressed data in GPUs.

“Tag” as used herein refers to metadata associated with a cache line that tracks information about the data stored within the cache line. Tags help identify the starting sector, size, and location of a tile within a cache line, enabling efficient retrieval of data. Some examples of tags are header information that includes starting sector identifiers and size identifiers for compressed tiles within a cache line.

“Cache” as used herein refers to a specialized form of memory used to store frequently accessed data to reduce the latency of data retrieval operations. In the context of graphics processing, caches are designed to store compressed tiles and include mechanisms such as multi-tag systems to optimize data storage and retrieval. An example of cache is multi-tag cache, which can store multiple compressed tiles with minimal fragmentation.

Although a “GPU” is mentioned throughout this disclosure, embodiments of the present disclosure cover more general or alternative computing devices, such as CPUs, application specific integrated circuits (ASICs), ICs, or also controllers executing instructions in a manner that is consistent with the memory storage architecture discussed herein.

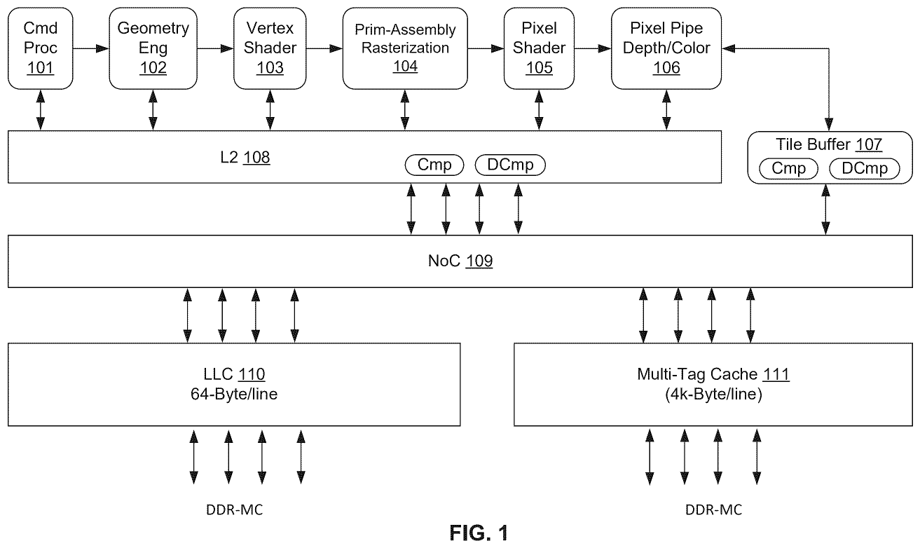

FIG. 1 is a block diagram depicting a subsystem memory hierarchy, according to an embodiment.

Referring to FIG. 1, the subsystem memory hierarchy is designed to optimize performance for graphics-intensive workloads. A multi-tag cache 111 may replace or be used with the last-level cache (LLC) 110, which enhances performance by reducing latency and improving throughput. This configuration allows the multi-tag cache 111 to efficiently handle the GPU's high throughput and low latency requirements, ultimately improving system efficiency. Although the term “LLC” is used throughout this disclosure, a system-level cache (SLC) may also be used in place of (or in addition to) the LLC according to various embodiments. SLC may refer to a high-level cache in SoC architectures that is shared across multiple processing units to optimize data access and reduce latency.

The memory hierarchy begins with the command processor (Cmd Proc) 101, which manages the GPU command stream and directs the flow of instructions to the various GPU components. Next, the geometry engine (Geometry Eng) 102 processes the geometric calculations necessary for rendering, such as transformations and lighting. The vertex shader 103 then applies effects to vertices as part of the rendering pipeline, while the primitive assembly and rasterization (Prim-Assembly Rasterization) stage 104 converts the vertices into geometric primitives and then into pixel data.

Once the pixel data is generated, the pixel shader 105 performs tasks such as shading, texturing, and lighting to produce the final pixel color. The pixel pipe depth/color 106 component manages depth and color operations, ensuring the correct layering and blending of images. After these processes, the tile buffer 107 temporarily stores tiles, with integrated compression (Cmp) and decompression (DCmp) units to handle the compressed tile data.

The L2 cache 108 and network-on-chip (NoC) 109, which enables data transfer between the components within the chip, sit between the GPU's core processing units (e.g., 101-106) and the LLC 110 and the multi-tag cache 111, storing uncompressed data for quicker access by the GPU.

The multi-tag cache 111 features a multi-tag (which may also be referred to as “dual-tag”) architecture that allows multiple compressed tiles to be stored within a single, large cache line. The multi-tag cache 111 is specifically optimized for GPU workloads, offering high throughput and low latency. The double data rate (DDR)-memory controller (MC) handles access to external dynamic random-access memory (DRAM), managing memory requests that cannot be fulfilled by the on-chip caches.

According to an embodiment, the multi-tag cache 111 is a multi-tag line architecture (e.g., multi-tag cache) that can hold up to two or more compressed tiles in a single cache line. For example, the multi-tag cache can have 4 KB/line (e.g., 128 sectors with 32-bytes per sector). For example, each cache line in the multi-tag cache 111 can hold up to 4 KB of data, and the multi-tag cache architecture can enable for the packing of some or all of two or more compressed tiles into a single cache line. As mentioned above, the multi-tag line can be further divided into 128 sectors, with each sector sized at 32 bytes. This sector-based organization enables precise alignment when a second compressed tile needs to span two or more cache lines. The architecture handles this alignment by positioning the tile at either the start or end of the line, ensuring that the maximum granularity loss in this process does not exceed the sector size minus 1 byte (e.g., 31 bytes per tile in case of the sector sized at 32 bytes). Although this alignment process may lead to a small amount of per-tile storage wastage, it is also possible to encounter a larger per-line amount of wastage. For example, if all tags within a cache line are utilized but the line's sectors are not fully occupied, the remaining unused portion of the line becomes inaccessible for storing additional data, leading to underutilization of the line.

Each tag within the multi-tag system may include information about three fields in the tag: address (identifies the data), starting sector (a beginning physical location in the cache line), and size of the compressed subtile (which denotes the amount of space a tile is using within a cache line, implying the ending physical location in the cache line). This setup simplifies the calculation of offsets when accessing the data, allowing for efficient retrieval of the tile information. In cases where a tile spans multiple cache lines, the system may assign the first cache line's address to the tile's base address, while the second cache line's address automatically accounts for the sector offset from the first line. This configuration minimizes any wasted space within the cache and ensures that all cache lines are fully utilized.

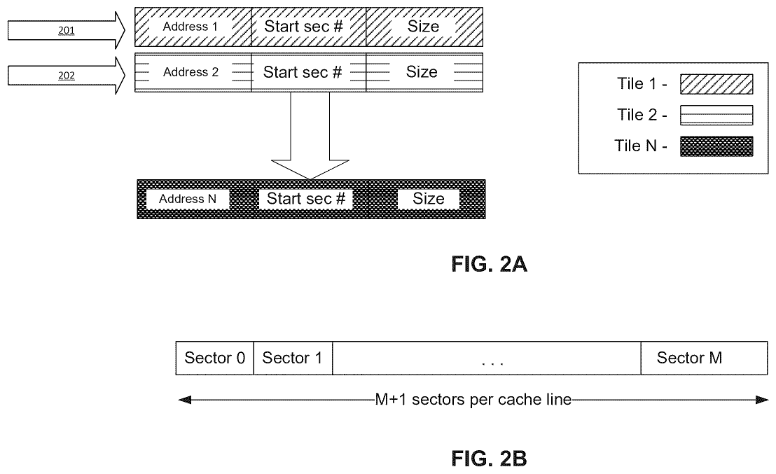

FIG. 2A illustrates a configuration of tags, according to an embodiment.

Referring to FIG. 2A, the concept of a cache line in the multi-tag cache architecture that uses multiple tags to manage the storage of compressed tiles is shown. Each tag corresponds to a different subtile stored within a cache line and contains metadata for retrieving that subtile. This metadata may include an address, the starting sector number (e.g., a location), labeled as “Start see #,” and the size of the subtile.

A sector refers to a fixed-size unit of data storage within a cache line. The multi-tag cache divides each cache line into smaller segments called sectors, with each sector representing a specific number of bytes. For the multi-tag cache architecture, each sector can be 32 bytes in size. Sectors serve as units for organizing and accessing data within the cache. When a compressed tile is stored in the cache, it occupies one or more sectors, depending on the tile's compressed size. The metadata associated with each tag tracks which sectors a particular tile occupies within the cache line, enabling efficient data access and retrieval.

Referring again to FIG. 2A, the first tag 201 represents an initial subtile stored in the cache line, tracking its starting sector and size. Similarly, the second tag 202 manages the metadata for a second subtile stored in the same cache line. This approach continues with additional tags, allowing for multiple compressed subtiles to be stored within a single cache line, depending on the compression ratio and the available space. By using multiple tags per cache line, the multi-tag cache architecture improves cache utilization, reduces fragmentation, and ensures more efficient storage and retrieval of data in GPU-intensive applications.

FIG. 2B illustrates a configuration of a cache line having M+1 sectors, according to an embodiment.

Referring to FIG. 2B, a cache line is composed of M+1 sectors, where “M+1” represents the total number of sectors in the cache line. These sectors are contiguous segments of the cache line, with each sector holding a fixed amount of data, such as, for example, 32 bytes in the multi-tag cache architecture.

Sector 0 and Sector 1 are shown at the beginning of the cache line, while Sector M appears at the end. The sectors in between, represented by dots (“ . . . ”), indicate the presence of additional sectors that continue across the cache line up until Sector M (the final sector in that cache line). The division of the cache line into sectors allows for more granular data storage, meaning that a single tile may occupy one or more sectors depending on its compressed size. This sector-based structure enables efficient packing of multiple compressed tiles into a single cache line while minimizing wasted space.

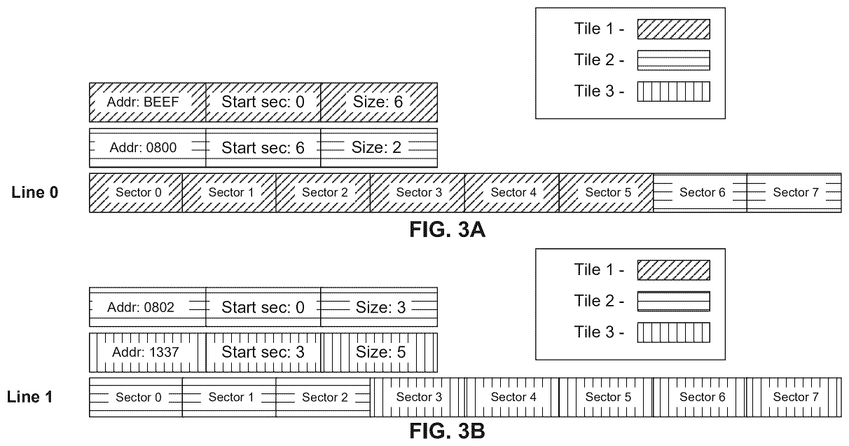

FIG. 3A illustrates line 0 of a multi-tag cache line example with two tags per line, according to an embodiment. FIG. 3B illustrates line 1 of a multi-tag cache line example with two tags per line, according to an embodiment.

FIGS. 3A and 3B demonstrate the functionality of the multi-tag cache line design with two tags per line. FIGS. 3A and 3B respectively show two cache lines labeled as “Line 0” and “Line 1,” each containing sectors that store compressed tile data. The tags associated with these cache lines contain the necessary metadata to track where the tiles are stored within the sectors.

Referring to FIGS. 3A-3B, there are three tiles (Tile 1, Tile 2, and Tile 3) stored across two cache lines (Line 0 and Line 1). Each tag may or may not refer to an entire tile, but each tag does refer to a subtile (a portion of a tile).

In Line 0, the first tile (Tile 1) is stored at the address “BEEF,” beginning at sector 0 and occupying 6 sectors. The second tile (Tile 2) in Line 0 starts at the address “0800,” beginning at sector 6 and occupying 2 sectors.

In Line 1, the second tile (Tile 2) starting at address “0802” occupies the first 3 sectors, while a third tile (Tile 3) beginning at address “1337” spans the remaining 5 sectors of the line. This example illustrates how multiple compressed tiles can be stored efficiently within a single cache line using the multi-tag cache architecture.

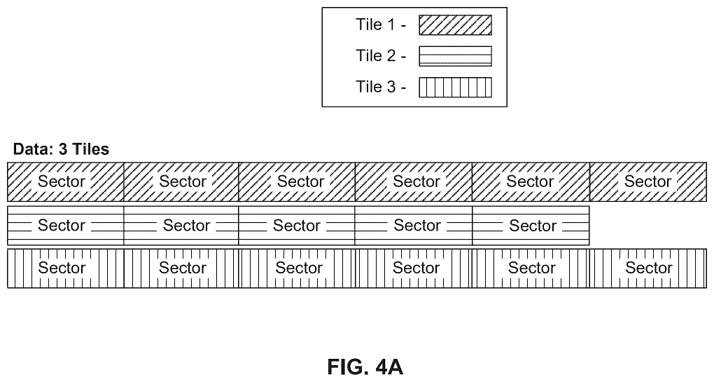

FIG. 4A illustrates three tiles having different data sizes, according to an embodiment.

Referring to FIG. 4A, each row represents a different tile, and each block within a row represents a sector that is occupied by that tile. The first row shows a tile occupying six sectors. The second row displays a tile that occupies five sectors. The third row shows another tile occupying six sectors. Notably, each of the rows in FIG. 4A are used to comparatively illustrate the size of the tiles (the number of sectors), and do not necessarily represent a cache line.

FIG. 4B illustrates a single-tag design requiring 3 lines to store the tiles shown in FIG. 4A, according to an embodiment.

FIG. 4C illustrates a multi-tag design requiring 2 lines to store the tiles shown in FIG. 4A, according to an embodiment.

Referring to FIGS. 4B and 4C, the efficiency gains achieved by using the multi-tag design compared to the single-tag design in cache architecture are illustrated. Each row in FIGS. 4B-4C correspond to a cache line. That is, there are three cache lines in FIG. 4B, and two cache lines in FIG. 4C.

Referring to FIG. 4B, this figure is labeled as a single-tag design, where each cache line can only store data associated with one tag. In this example, three cache lines are required to store the data from three tiles. Due to the limitations of the single-tag approach, significant portions of the cache lines remain unused, as shown by the empty (white/grey) sectors, resulting in wasted space and internal fragmentation.

Referring to FIG. 4C, multiple tags per cache line are illustrated. Here, the same data from three tiles is stored using only two cache lines, significantly reducing the number of cache lines required. The multi-tag system effectively eliminates the wasted space present in the single-tag approach by allowing compressed tiles to be packed more efficiently within each cache line. As a result, fewer cache lines are necessary to store the same amount of data, reducing internal fragmentation and optimizing cache utilization.

One of the benefits of the multi-tag cache architecture in the cache is reduced tag storage overhead. The multi-tag cache uses larger cache lines than typical caches, allowing for more efficient storage of data while reducing the amount of metadata (tags) needed to track that data. The larger line sizes reduce the overall number of tags per unit of data, even when multiple tags are used per cache line. This reduction in tags minimizes the storage overhead associated with tracking data within the cache, leading to more efficient use of the available memory.

For example, compare the tag overhead in a typical cache using 64-byte lines to the tag overhead in a multi-tag cache using 1 KB lines. In the typical cache, each cache line may require a tag consisting of 40 bits of metadata. When calculated against the 64 bytes of data stored in the cache line, the overhead amounts to roughly 7.8%. In contrast, the multi-tag cache with 1 KB lines can store much larger quantities of data per line. Even with two tags per line, the overhead is significantly reduced (since the amount of data per line is significantly increased). Accordingly, the tag overhead in the multi-tag cache may drop to roughly 1.0%, demonstrating the efficiency gains achieved by using larger cache lines in conjunction with multiple tags.

This reduction in tag overhead is an advantage of the multi-tag cache architecture, particularly in GPU-intensive applications where large amounts of compressed tile data must be stored and accessed quickly. By using larger cache lines and reducing the number of tags needed per data quantity, the multi-tag cache architecture minimizes the overhead typically associated with cache management. This results in more efficient memory utilization, which translates to improved performance in processing graphics and other data-intensive tasks.

Another benefit of the multi-tag cache architecture is reduced request overhead. The multi-tag-based caches in the multi-tag cache architecture store tiles that are much larger than those typically found in other caches. As a result, the number of memory requests required to transfer a given amount of contiguous data is significantly reduced. This reduction in request overhead leads to faster data retrieval and improved overall performance in GPU-intensive applications.

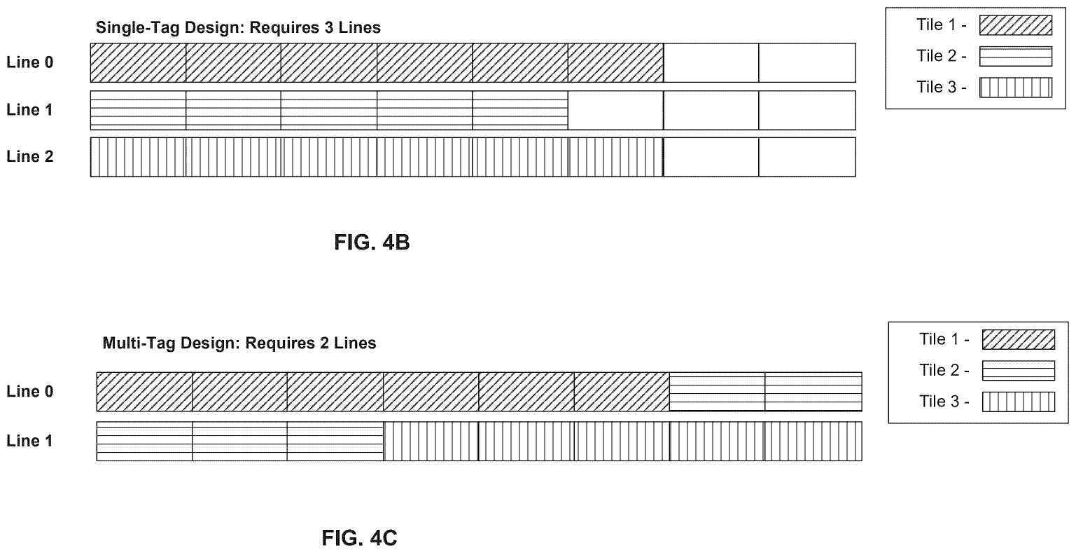

FIG. 5 illustrates reading data from cache lines of a first size based on one or more requests, according to an embodiment.

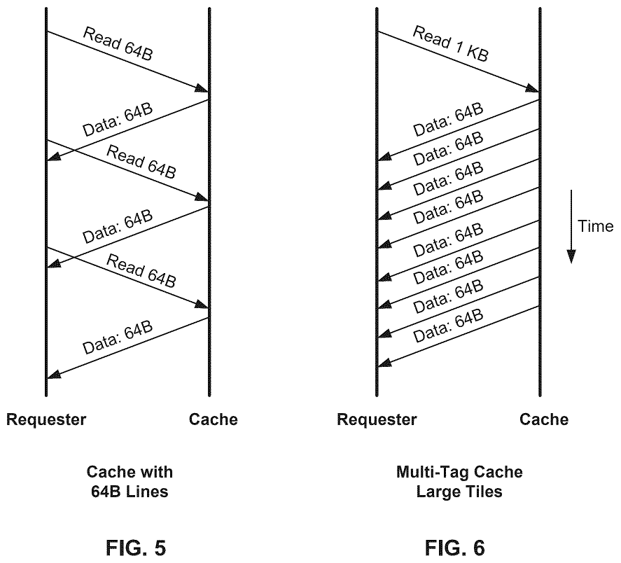

FIG. 6 illustrates reading data from cache lines of a second size larger than the first size based on one or more requests, according to an embodiment.

Referring to FIG. 5, this figure illustrates the behavior of a cache using 64-byte cache lines. In this system, each request retrieves only 64 bytes of data, meaning multiple read requests must be issued to transfer a larger amount of contiguous data. The arrows in FIG. 5 show the back-and-forth communication between the requester and the cache, with each request followed by a 64-byte data transfer. This process is repeated for every subsequent 64-byte segment, resulting in increased overhead due to the multiple requests required.

Referring to FIG. 6, this figure demonstrates the efficiency of the multi-tag cache with large tiles. Here, a single read request can retrieve an entire 1 KB cache line. After the initial request, the cache transfers all the data segments—each still 64 bytes-without the need for additional requests. FIG. 6 visually represents this improvement by showing a single request followed by the immediate transfer of multiple 64-byte segments. Although 64-byte segments are depicted and described with respect to FIG. 6, embodiments presented herein encompass situations in which the transfer channel (e.g., NoC, bus, etc. . . . ) can transfer more bytes per data segment than 64 bytes.

Accordingly, the multi-tag cache architecture's system reduces the number of requests needed to transfer large amounts of data, which in turn lowers latency and improves performance.

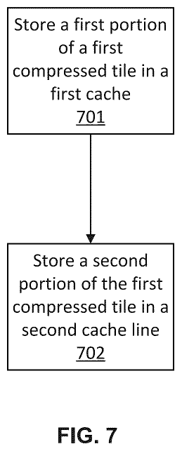

FIG. 7 is a flowchart illustrating a multi-tag cache architecture method, according to an embodiment.

One or more of the steps illustrated in FIG. 7 may be performed by a processor or processing module associated with a cache storage device configured to implement the described multi-tag cache architecture.

Referring to FIG. 7, in step 701, a first portion of a first compressed tile is stored in a first cache. The first portion may be stored in a cache storage device, such as one implemented within a GPU or an SLC.

In step 702, a second portion of the first compressed tile is stored in a second cache line of the cache storage device. This step may be necessary when the compressed tile spans multiple cache lines due to its size or alignment requirements.

For example, the first portion of the first compressed tile stored in the first cache line may correspond to the portion of Tile 2 that is stored in Line 0 of FIG. 4C, and the second portion of the first compressed tile stored in the second cache line may correspond to the portion of Tile 2 that is stored in Line 1 of FIG. 4C. As discussed above, the first portion and the second portion of an individual compressed tile each may have their own tags, including header information identifying an address, a starting sector, and/or a size parameter. This tagging mechanism reduces fragmentation and allows multiple compressed tiles to coexist within the same cache line.

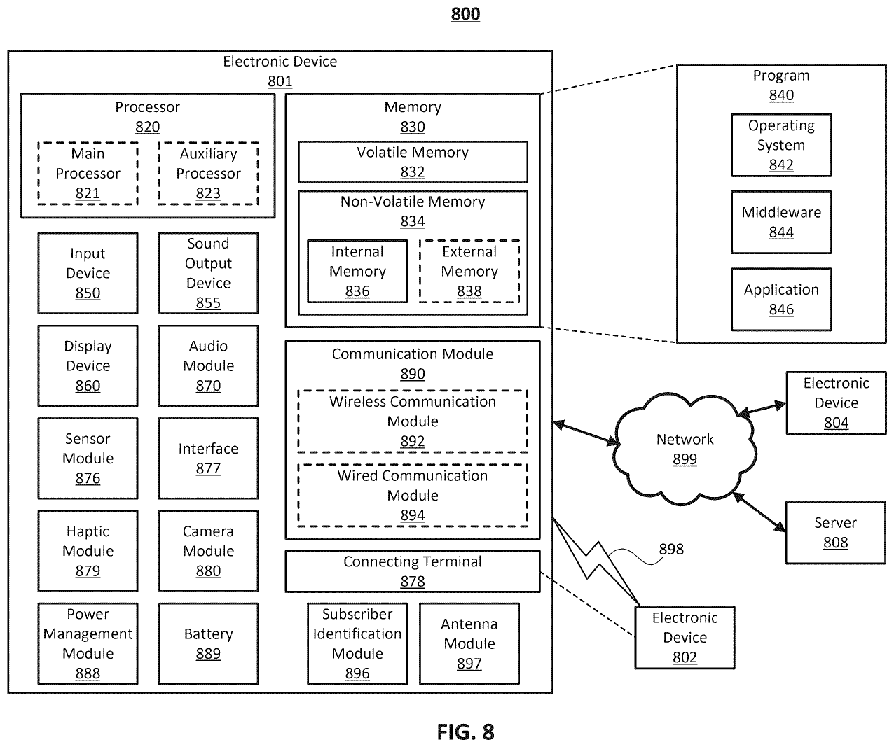

FIG. 8 is a block diagram of an electronic device in a network environment 800, according to an embodiment.

The multi-tag cache architecture can be integrated into the electronic device structure outlined in FIG. 8 to optimize GPU-related tasks and improve overall system efficiency. The multi-tag cache, with its large cache line architecture, can be closely related to components such as the auxiliary processor 823, which may include a GPU or an ISP. By incorporating the multi-tag cache within the auxiliary processor 823, the device can manage large, compressed tiles more effectively, significantly reducing latency and enhancing throughput during graphics rendering and image processing tasks.

Referring to FIG. 8, an electronic device 801 in a network environment 800 may communicate with an electronic device 802 via a first network 898 (e.g., a short-range wireless communication network), or an electronic device 804 or a server 808 via a second network 899 (e.g., a long-range wireless communication network). The electronic device 801 may communicate with the electronic device 804 via the server 808. The electronic device 801 may include a processor 820, a memory 830, an input device 850, a sound output device 855, a display device 860, an audio module 870, a sensor module 876, an interface 877, a haptic module 879, a camera module 880, a power management module 888, a battery 889, a communication module 890, a subscriber identification module (SIM) card 896, or an antenna module 897. In one embodiment, at least one (e.g., the display device 860 or the camera module 880) of the components may be omitted from the electronic device 801, or one or more other components may be added to the electronic device 801. Some of the components may be implemented as a single IC. For example, the sensor module 876 (e.g., a fingerprint sensor, an iris sensor, or an illuminance sensor) may be embedded in the display device 860 (e.g., a display).

The processor 820 may execute software (e.g., a program 840) to control at least one other component (e.g., a hardware or a software component) of the electronic device 801 coupled with the processor 820 and may perform various data processing or computations.

As at least part of the data processing or computations, the processor 820 may load a command or data received from another component (e.g., the sensor module 876 or the communication module 890) in volatile memory 832, process the command or the data stored in the volatile memory 832, and store resulting data in non-volatile memory 834. The processor 820 may include a main processor 821 (e.g., a CPU or an application processor (AP)), and an auxiliary processor 823 (e.g., a GPU, an ISP, a sensor hub processor, or a communication processor (CP)) that is operable independently from, or in conjunction with, the main processor 821. Additionally or alternatively, the auxiliary processor 823 may be adapted to consume less power than the main processor 821, or execute a particular function. The auxiliary processor 823 may be implemented as being separate from, or a part of, the main processor 821.

The auxiliary processor 823 may control at least some of the functions or states related to at least one component (e.g., the display device 860, the sensor module 876, or the communication module 890) among the components of the electronic device 801, instead of the main processor 821 while the main processor 821 is in an inactive (e.g., sleep) state, or together with the main processor 821 while the main processor 821 is in an active state (e.g., executing an application). The auxiliary processor 823 (e.g., an image signal processor or a communication processor) may be implemented as part of another component (e.g., the camera module 880 or the communication module 890) functionally related to the auxiliary processor 823.

The memory 830 may store various data used by at least one component (e.g., the processor 820 or the sensor module 876) of the electronic device 801. The various data may include, for example, software (e.g., the program 840) and input data or output data for a command related thereto. The memory 830 may include the volatile memory 832 or the non-volatile memory 834. Non-volatile memory 834 may include internal memory 836 and/or external memory 838.

The program 840 may be stored in the memory 830 as software, and may include, for example, an operating system (OS) 842, middleware 844, or an application 846.

The input device 850 may receive a command or data to be used by another component (e.g., the processor 820) of the electronic device 801, from the outside (e.g., a user) of the electronic device 801. The input device 850 may include, for example, a microphone, a mouse, or a keyboard.

The sound output device 855 may output sound signals to the outside of the electronic device 801. The sound output device 855 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 860 may visually provide information to the outside (e.g., a user) of the electronic device 801. The display device 860 may include, for example, a display, a hologram device, or a projector and control circuitry to control a corresponding one of the display, hologram device, and projector. The display device 860 may include touch circuitry adapted to detect a touch, or sensor circuitry (e.g., a pressure sensor) adapted to measure the intensity of force incurred by the touch.

The audio module 870 may convert a sound into an electrical signal and vice versa. The audio module 870 may obtain the sound via the input device 850 or output the sound via the sound output device 855 or a headphone of an external electronic device 802 directly (e.g., wired) or wirelessly coupled with the electronic device 801.

The sensor module 876 may detect an operational state (e.g., power or temperature) of the electronic device 801 or an environmental state (e.g., a state of a user) external to the electronic device 801, and then generate an electrical signal or data value corresponding to the detected state. The sensor module 876 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 877 may support one or more specified protocols to be used for the electronic device 801 to be coupled with the external electronic device 802 directly (e.g., wired) or wirelessly. The interface 877 may include, for example, a high-definition multimedia interface (HDMI), a universal serial bus (USB) interface, a secure digital (SD) card interface, or an audio interface.

A connecting terminal 878 may include a connector via which the electronic device 801 may be physically connected with the external electronic device 802. The connecting terminal 878 may include, for example, an HDMI connector, a USB connector, an SD card connector, or an audio connector (e.g., a headphone connector).

The haptic module 879 may convert an electrical signal into a mechanical stimulus (e.g., a vibration or a movement) or an electrical stimulus which may be recognized by a user via tactile sensation or kinesthetic sensation. The haptic module 879 may include, for example, a motor, a piezoelectric element, or an electrical stimulator.

The camera module 880 may capture a still image or moving images. The camera module 880 may include one or more lenses, image sensors, image signal processors, or flashes. The power management module 888 may manage power supplied to the electronic device 801. The power management module 888 may be implemented as at least part of, for example, a power management integrated circuit (PMIC).

The battery 889 may supply power to at least one component of the electronic device 801. The battery 889 may include, for example, a primary cell which is not rechargeable, a secondary cell which is rechargeable, or a fuel cell.

The communication module 890 may support establishing a direct (e.g., wired) communication channel or a wireless communication channel between the electronic device 801 and the external electronic device (e.g., the electronic device 802, the electronic device 804, or the server 808) and performing communication via the established communication channel. The communication module 890 may include one or more communication processors that are operable independently from the processor 820 (e.g., the AP) and supports a direct (e.g., wired) communication or a wireless communication. The communication module 890 may include a wireless communication module 892 (e.g., a cellular communication module, a short-range wireless communication module, or a global navigation satellite system (GNSS) communication module) or a wired communication module 894 (e.g., a local area network (LAN) communication module or a power line communication (PLC) module). A corresponding one of these communication modules may communicate with the external electronic device via the first network 898 (e.g., a short-range communication network, such as BLUETOOTH™, wireless-fidelity (Wi-Fi) direct, or a standard of the Infrared Data Association (IrDA)) or the second network 899 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 892 may identify and authenticate the electronic device 801 in a communication network, such as the first network 898 or the second network 899, using subscriber information (e.g., international mobile subscriber identity (IMSI)) stored in the subscriber identification module 896.

The antenna module 897 may transmit or receive a signal or power to or from the outside (e.g., the external electronic device) of the electronic device 801. The antenna module 897 may include one or more antennas, and, therefrom, at least one antenna appropriate for a communication scheme used in the communication network, such as the first network 898 or the second network 899, may be selected, for example, by the communication module 890 (e.g., the wireless communication module 892). The signal or the power may then be transmitted or received between the communication module 890 and the external electronic device via the selected at least one antenna.

Commands or data may be transmitted or received between the electronic device 801 and the external electronic device 804 via the server 808 coupled with the second network 899. Each of the electronic devices 802 and 804 may be a device of a same type as, or a different type, from the electronic device 801. All or some of operations to be executed at the electronic device 801 may be executed at one or more of the external electronic devices 802, 804, or 808. For example, if the electronic device 801 should perform a function or a service automatically, or in response to a request from a user or another device, the electronic device 801, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 801. The electronic device 801 may provide the outcome, with or without further processing of the outcome, as at least part of a reply to the request. To that end, a cloud computing, distributed computing, or client-server computing technology may be used, for example.

Moreover, the multi-tag cache can be coupled with the processor 820, particularly the main processor 821 and the auxiliary processor 823, to ensure seamless execution of graphics-intensive applications. The multi-tag system of the cache allows for efficient storage of multiple compressed tiles within a single cache line, thereby optimizing the use of the volatile memory 832 and non-volatile memory 834 within the memory 830. This integration results in faster data processing, as the processor 820 can quickly access large amounts of data stored in the multi-tag cache, reducing the need for frequent memory accesses and improving overall device performance.

The multi-tag cache also enhances the efficiency of the communication module 890 by reducing memory traffic during data transfers between the memory 830 and other components such as the display device 860 or the camera module 880. By storing large quantities of compressed data within fewer cache lines, the multi-tag cache architecture minimizes the burden of the communication module 890 when retrieving data from external memory or transferring data across networks 898 and 899. This improved memory utilization ensures that the device remains responsive and capable of handling demanding tasks like gaming, augmented reality, or high-resolution image processing.

Furthermore, the power management module 888 can work in conjunction with the multi-tag cache to optimize power consumption during GPU-intensive operations. The multi-tag's efficient data handling reduces the load on the auxiliary processor 823, enabling the device to conserve battery 889 power while maintaining high performance. This integration creates a more power-efficient electronic device, making it well-suited for applications that require extended battery life without compromising on processing power.

By embedding the multi-tag cache within the device's existing structure, including the processor 820, memory 830, and/or communication module 890, the present disclosure offers a comprehensive solution that enhances the performance and efficiency of modern electronic devices, particularly those with high demands for graphics processing and data-intensive applications.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple compact discs (CDs), disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A cache storage device comprising:
a first cache line storing a first portion of a first compressed tile; and
a second cache line storing a second portion of the first compressed tile.

2. The cache storage device of claim 1, wherein at least one of the first portion of the first compressed tile is stored based on a first tag or the second portion of the first compressed tile is stored based on a second tag.

3. The cache storage device of claim 2, wherein at least one of the first tag or the second tag includes header information identifying at least one of an address, a starting sector, or a size parameter.

4. The cache storage device of claim 2, wherein at least one of the first tag or the second tag are associated with a particular set of segments within a respective cache line.

5. The cache storage device of claim 1, wherein at least one of the first cache line or the second cache line further stores a first portion of a second compressed tile.

6. The cache storage device of claim 5, wherein at least one of the first cache line or the second cache line further stores a first portion of a third compressed tile.

7. The cache storage device of claim 5, wherein all available sectors in at least one of the first cache line or the second cache line are used for storing portions of the first and second compressed tiles.

8. The cache storage device of claim 1, wherein a graphics processing unit (GPU) accesses the first compressed tile stored in the first cache line and the second cache line.

9. The cache storage device of claim 1, wherein at least one of the first cache line and the second cache line is assigned two or more tags.

10. A method comprising:
storing a first portion of a first compressed tile in a first cache line of a cache storage device; and
storing a second portion of the first compressed tile in a second cache line of a cache storage device.

11. The method of claim 10, wherein at least one of the first portion of the first compressed tile is stored based on a first tag or the second portion of the first compressed tile is stored based on a second tag.

12. The method of claim 11, wherein at least one of the first tag or the second tag includes header information identifying at least one of an address, a starting sector, or a size parameter.

13. The method of claim 11, wherein at least one of the first tag or the second tag are associated with a particular set of segments within a respective cache line.

14. The method of claim 10, wherein at least one of the first cache line or the second cache line further stores a first portion of a second compressed tile.

15. The method of claim 14, wherein at least one of the first cache line or the second cache line further stores a first portion of a third compressed tile.

16. The method of claim 14, wherein all available sectors in at least one of the first cache line or the second cache line are used for storing portions of the first and second compressed tiles.

17. The method of claim 10, wherein a graphics processing unit (GPU) accesses the first compressed tile stored in the first cache line and the second cache line.

18. The method of claim 10, wherein at least one of the first cache line or the second cache line is assigned two or more tags.

19. A cache storage device comprising:
a first cache line storing a first portion of a compressed tile in a sector of the first cache line based on a tag assigned to the first cache line; and
a second cache line storing a second portion of the compressed tile in a sector of the second cache line based on a tag assigned to the second cache line.

20. The cache storage device of claim 19, wherein the tag assigned to the first cache line and the tag assigned to the second cache line each include header information identifying at least one of an address, a starting sector, or a size parameter.
